(19) United States
(12) Patent Application Publication
(10) Pub. No.: US 2005/0257252 A1
(43) Pub. Date: Nov. 17, 2005

(54) Method for protecting privileged device functions

(76) Inventor: Art Shelest, Sammamish, WA (US)

Correspondence Address: Art Shelest, 500 233rd Ave NE, Sammamish, WA, 98074, US

(21) Appl. No.: 11/116,887

(22) Filed: Apr. 27, 2005

Related U.S. Application Data
(60) Provisional application No. 60/566,136, filed on Apr. 28, 2004.

(51) Int. Cl. H04L 9/00

(52) U.S. Cl. 726/5

(57) ABSTRACT

A system and method are incorporated within electronic devices for preventing unauthorized use of privileged functions by legitimate or illegitimate users. The system includes a trusted agent, a secure communication channel between the trusted agent and the device, and an interface for the user to communicate with the trusted agent.

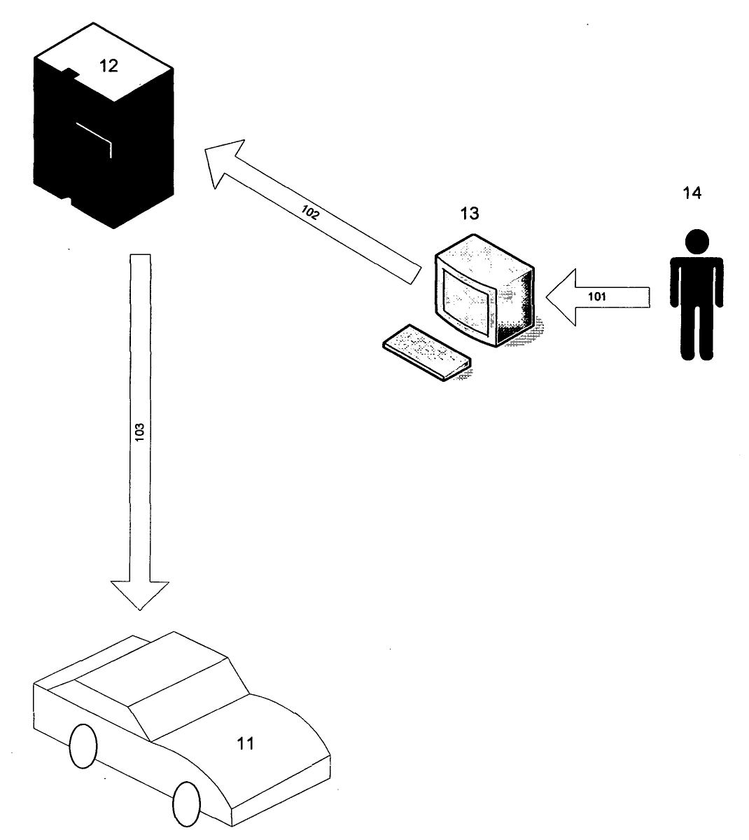

### This application claims the benefit of provisional patent application Ser. No. 60/566136, filed Apr. 28, 2004—by the present inventor.

### FEDERALLY SPONSERED RESEARCH

Not Applicable

### CROSS-REFERENCE TO RELATED APPLICATIONS

None

### BACKGROUND OF THE INVENTION

1. Technical Field

This invention relates to control and protection of privileged functions of devices, specifically the functions that must not be directly accessible by the person possessing the device.

2. Prior Art

The original approach of manufacturing and selling electronic devices assumes that all functions of the device are accessible by the person possessing the device. For example, a person who purchased a VCR has full access to all capabilities of the VCR, including loading, playing, recording and ejecting magnetic tapes at any time. In some instances, certain functions of the device need not be exposed to the consumer; for example, some DVD players have hidden features such as diagnostic menus, only to be used by professionals who know the secret button combinations.

Between the device functions that are freely available to the consumer (e.g. playing a disk) and device functions that should never be used by a consumer (e.g. diagnostic menu) lies the functionality the makers of the electronic equipment wants to provide on condition that it is used responsibly and appropriately, such as copying a protected DVD.

Prior to this invention, the party that desired to control the use of privileged functions had to provide a specially manufactured device, communication infrastructure and the communication protocol controlling the usage of the device.

For example, a satellite TV box converts encrypted Pay-Per-View signal into viewable TV programming acting on commands from the satellite TV provider. In this instance the protected function is the Pay-Per-View content access, and it must be precisely controlled by the satellite TV provider to protect from the theft of service.

Traditionally, the entity that desires to control privileged functions of the device must provide a custom device to the customer, equip device with connectivity technology (such as a modem for the phone line) and implement a communication protocol to remotely control the device. All these requirements add considerable expense compared to regular consumer devices like a telephone or a computer printer, and having to be plugged into a trusted communication line (e.g. phone line) is an inconvenience for the customer.

### BRIEF SUMMARY OF THE INVENTION

Embodiments of the present invention include a method for implementing privileged functions in electronic devices. These privileged functions can only be controlled with the assistance of trusted agents external to the device that are capable of establishing a secure communication channel with the device itself over an arbitrary communication link.

With the ability to precisely control privileged functions, designers and manufacturers of consumer electronics, computer peripherals and other devices can implement safeguards to ensure that the privileged operations are not used improperly or in violation of applicable laws. My invention also allows dynamically changing the policies governing privileged functions, in response to changes in laws or business priorities or ownership of specific devices.

The invention gives manufacturers ability to implement privileged functions in electronic devices while retaining precise control of how and when privileged functions are used.

In another aspect of the invention, the secure communication channel between the device and the trusted agent provides guarantee to the user that the privileged function is performed in precise accordance with instructions from the trusted agent.

### DESCRIPTION OF THE DRAWINGS

The present invention is described in detail below with reference to the attached drawing figures, wherein:

11 is the device implementing the method of the invention (a car engine management computer)

12 is the remote trusted agent (a computer controlled by the automaker)

13 is the user's computer connected with the internet and with the car

14 is the user who desires to change engine management computer settings

The following sequence of events allows user to perform a privileged function with the assistance of a trusted agent:
User 14 enters a request 101 into computer 13 to modify an engine setting
Computer 13 makes connection 102 to the remote trusted agent 12
The remote trusted agent 12 evaluates the request, approves it and after negotiating secure channel 103 sends a command to the device 11
Device 11 accepts the command and the requested change takes place.

1. A method for implementing a consumer electronic device or a computer peripheral which requires secure communication with a remote trusted agent for performing privileged functions, the method comprising:
user communicating with the remote trusted agent using computer, telephone or other human-machine interface to place service requests
remote trusted agent evaluating appropriateness of service requests entered by the user, optionally creating audit/billing records of the transaction, establishing secure communication channel with the device and issuing secure commands controlling the user's device
commands being transferred via regular unprotected communication lines such as Internet or other computer networks
user's device verifying identity of the remote trusted agent and complying with the commands given by the remote trusted agent

2. The method of claim 1, where the remote trusted agent can modify user's request prior to carrying out the commands.

3. The method of claim 1, where an untrusted PC serves as the network-to-bus communication bridge for devices that don't implement network access interface (e.g. non-network computer printers, computer displays, etc).

4. The method of claim 1, where an untrusted PC serves as the network-to-network communication bridge for devices that don't implement enough connectivity technology to reach the remote trusted agent (e.g. Ethernet enabled printers that don't speak TCP/IP)

5. The method of claim 1, where security credentials and the policy of the user device is detachable from the device in the form of self-contained secret-bearing device such as smartcard, USB key, etc.

6. The method of claim 1, where user places service requests with the remote trusted agent using Web interface.

7. The method of claim 1, where user places service requests with the remote trusted agent using software that runs on a PC able to communicate with the remote trusted agent.

8. The method of claim 1, where a device's capabilities and integrity can be affirmed by the remote trusted agent before access to valuable content is granted.

9. The method of claim 8, where device performs a specialized computationally intensive operation within time constraints set to differentiate devices from the general purpose computers.

10. Application of method 1 for creating “secure displays”, “secure printers”, “secure speakers” and other secure output devices capable of representing content from a trusted source.

11. Application of method 1 for creating “pay per use” devices where a privileged function of a device (such as certain reconfiguration action) is billed to the user.

12. Application of method 1 for controlling physical security systems.

13. Application of method 1 for placing external constraints on configuring devices where invalid combinations of settings are undesirable.

14. Application of method 8 for creating “safe to play” devices, capable of displaying, playing or storing digital content according to the policy of the content's owner or content's distributor.
